(19) United States
(12) Patent Application Publication
(10) Pub. No.: US 2017/0192166 A1
(43) Pub. Date: Jul. 6, 2017

(54) LIGHT SOURCE MODULE AND DISPLAY DEVICE

(71) Applicant: Young Lighting Technology Inc., Hsin-Chu (TW)

(72) Inventor: Cheng-Hsi Hsieh, Hsin-Chu (TW)

(73) Assignee: Young Lighting Technology Inc., Hsin-Chu (TW)

(21) Appl. No.: 15/390,747

(22) Filed: Dec. 27, 2016

(30) Foreign Application Priority Data
Jan. 4, 2016 (TW) 105100099

(51) Int. Cl. F21V 8/00

(52) U.S. Cl. CPC G02B 6/0091; G02B 6/0036; G02B 6/0016; G02B 6/0061

(57) ABSTRACT

A light source module including a light guide plate, a light source, and an adhesive material is provided. The light guide plate having a light-coupling region and a light-emitting region includes a light-incident surface, a first and a second surfaces opposite to the first surface, a plurality of first and second microstructures. The light-coupling region is located between the light-incident surface and the light-emitting region. The light-incident surface is connected to the first and the second surfaces. The first microstructures are disposed in the light-emitting region and protrude from the first surface. The second microstructures are disposed in the light-coupling region and protrude from at least one of the first and the second surfaces. A shape of the first microstructures is different from that of the second microstructures. The light source is disposed beside the light-incident surface. The adhesive material is disposed between the light source and the light-incident surface.

### CROSS-REFERENCE TO RELATED APPLICATION

This application claims the priority benefit of Taiwan application serial no. 105100099, filed on Jan. 4, 2016. The entirety of the above-mentioned patent application is hereby incorporated by reference herein and made a part of this specification.

### BACKGROUND OF THE INVENTION

Field of the Invention

The invention relates to a light source module and a display device.

Description of Related Art

As the demand for computing performance, size of the display panel, resolution, and brightness of mobile display devices continues to increase, power consumption of the mobile display devices also continues to increase at the same time. For example, power consumption of a backlight module in a liquid crystal display accounts for a large portion of energy consumption.

To solve the above-identified issue, in a backlight module, 1D local dimming may be achieved through a light guide plate of a specific structural design (i.e., a light beam emitted by a light source being transmitted along a uniaxial direction in the light guide plate). Moreover, an algorithm of a driver integrated chip in the liquid crystal display and a specific image processing method are further combined, such that power consumption of the backlight module may be greatly reduced and the effect of contrast may be enhanced.

However, the current light guide plate for 1D local dimming is only adapted for the case where air exists between the light source and the light guide plate. When the light source and the light guide plate for 1D local dimming are bonded by an optical clear adhesive (OCR), the efficiency of coupling light of the light source into the light guide plate is enhanced. However, since the refractivity of the optical clear adhesive and the air is different, a refracting angle of the light beam incident to the light guide plate is changed. As a result, after being incident to the light guide plate, part of the light beam cannot be transmitted through total reflection in the light guide plate, and a phenomenon of light leakage is caused in a light-emitting region of the light guide plate. On the other hand, an angle of total reflection in the light guide plate of part of the light beam entering the light guide plate cannot be changed by means of microstructures on the light guide plate. Therefore, the part of the light beam cannot be transmitted along one single axis in the light guide plate. Instead, the phenomenon of stray light in a lateral direction with respect to the single axis is caused in the light guide plate, and the effect of 1D local dimming is reduced.

For a clearer illustration of the foregoing optical behavior, referring to FIG. 1A and FIG. 1B, FIG. 1A is a schematic diagram of an optical simulation result of a case where air exists between a light source and a light guide plate for 1D local dimming, and FIG. 1B is a schematic diagram of an optical simulation result of a case where an optical clear adhesive is disposed between a light source and a light guide plate for 1D local dimming. FIG. 1A shows that the light beam emitted by the light source is transmitted along a uniaxial direction in the light guide plate, while FIG. 1B shows the aforementioned phenomena of lateral stray light and light leakage. Therefore, how to solve the above-identified issue is indeed one of the current key research areas for the researchers in the art.

The information disclosed in this “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention provides a light source module capable of effectively mitigating phenomena of stray light and light leakage.

The invention provides a display device including the aforementioned light source module and having excellent optical quality.

Other objects and advantages of the invention can be further illustrated by the technical features broadly embodied and described as follows.

In order to achieve one or a portion of or all of the objects or other objects, an embodiment of the invention provides a light source module including a light guide plate, a light source, and an adhesive material. The light guide plate includes a light-coupling region and a light-emitting region. The light guide plate includes a light-incident surface, a first surface, a second surface, a plurality of first microstructures, and a plurality of second microstructures. The light-coupling region is located between the light-incident surface and the light-emitting region. The first surface is connected to the light-incident surface. The second surface is connected to the light-incident surface and is disposed opposite to the first surface. The first microstructures are disposed in the light-emitting region and protrude from the first surface. The second microstructures are disposed in the light-coupling region and protrude from at least one of the first surface and the second surface, wherein a shape of the first microstructures is different from a shape of the second microstructures. The light source is disposed beside the light-incident surface. The adhesive material is disposed between the light source and the light-incident surface.

In order to achieve one or a portion of or all of the objects or other objects, an embodiment of the invention provides a display device including a display panel and the above-described light source module.

In summary of the above, the embodiments of the invention may achieve at least one of the advantages or effects listed below. In the light source module of the embodiments of the invention, the adhesive material is disposed between the light source and the light guide plate. Moreover, the second microstructures protruding from at least one of the first surface and the second surface are disposed in the light-coupling region between the light-incident surface and the light-emitting region. Such configurations may effectively increase the proportion of total reflection of the light beam in the light guide plate, effectively mitigate the phenomena of lateral stray light and light leakage, and further enhance the effect of 1D local dimming. Since the display device of the embodiments of the invention includes the above-described light source module, the display device has excellent optical quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic diagram illustrating an optical simulation result of a case where air exists between a light source and a light guide plate for 1D local dimming.

FIG. 1B is a schematic diagram illustrating an optical simulation result of a case where an optical clear adhesive is disposed between a light source and a light guide plate for 1D local dimming.

FIG. 2A is a top schematic diagram illustrating a display device of one embodiment of the invention.

FIG. 2B is a cross-sectional schematic diagram illustrating the display device of FIG. 2A along a cutting line A-A.

FIG. 2C is a schematic diagram illustrating an optical simulation result of a light source module of FIG. 2A and FIG. 2B.

FIG. 2D is a cross-sectional schematic diagram illustrating a display device along a cutting line A-A according to another embodiment of the invention.

FIG. 2E is a cross-sectional schematic diagram illustrating a display device along a cutting line A-A according to another embodiment of the invention.

FIG. 3A is a cross-sectional schematic diagram illustrating the display device of FIG. 2A along a cutting line B-B.

FIG. 3B is a cross-sectional schematic diagram illustrating a display device along a cutting line B-B according to another embodiment of the invention.

FIG. 4A is a cross-sectional schematic diagram illustrating the display device of FIG. 2A along a cutting line C-C.

FIG. 4B is a cross-sectional schematic diagram illustrating a display device along a cutting line C-C according to another embodiment of the invention.

FIG. 4C is a perspective schematic diagram illustrating second microstructures in a display device according to another embodiment of the invention.

FIG. 4D is a cross-sectional schematic diagram illustrating a display device along a cutting line C-C according to another embodiment of the invention.

FIG. 4E is a cross-sectional schematic diagram illustrating a display device along a cutting line C-C according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

To detail the display device of the embodiment of the invention, a display device 100 of the embodiment may be construed as being in a space constructed by an X-axis, a Y-axis, and a Z-axis, wherein an X-axis direction is substantially parallel to a light-incident surface 212 and extends along a horizontal direction. The Z-axis is substantially perpendicular to the X-axis direction and extends along a normal direction (perpendicular direction) of a first surface 214. Moreover, a Y-axis direction is perpendicular to the X-axis direction and is also perpendicular to a Z-axis direction.

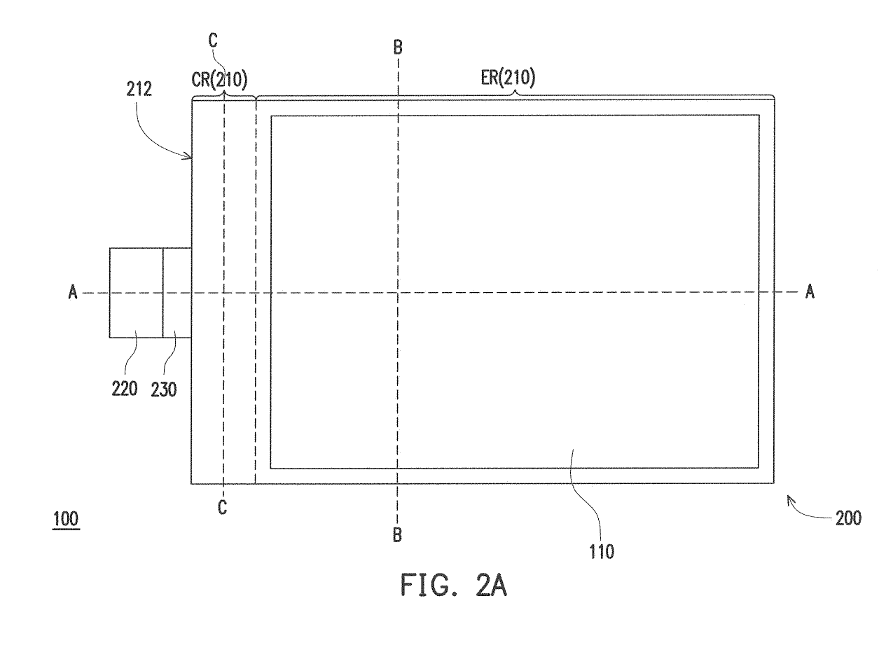

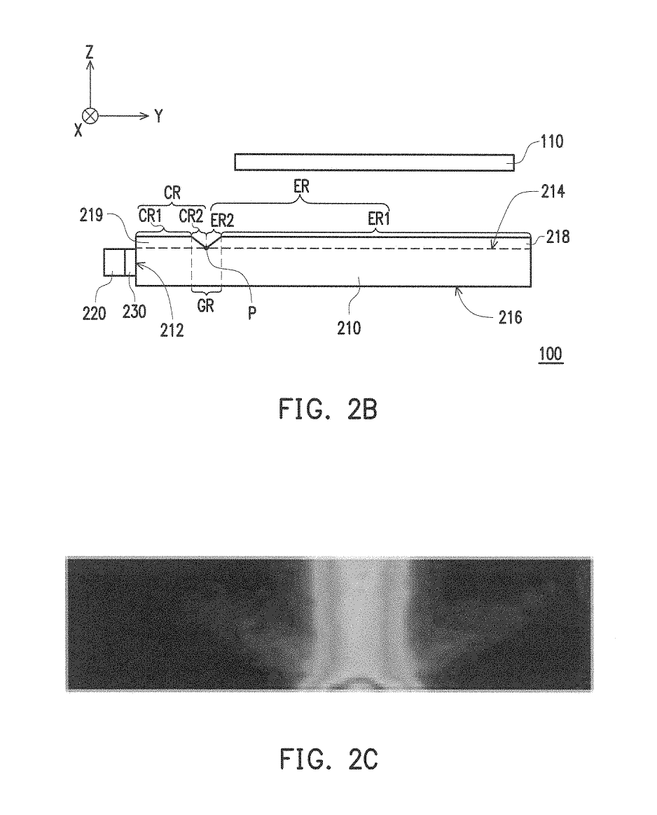

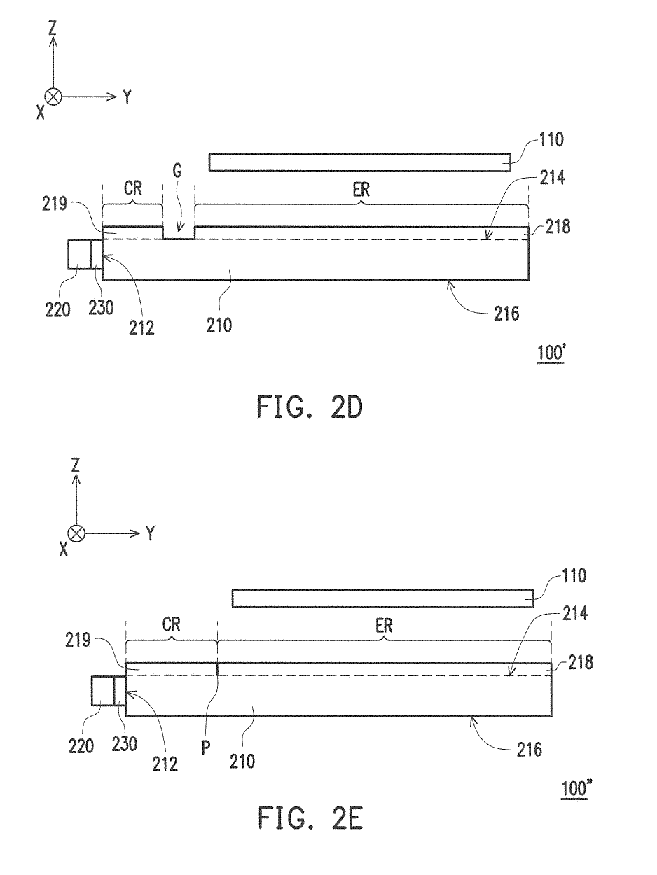

FIG. 2A is a top schematic diagram illustrating a display device of one embodiment of the invention. FIG. 2B is a cross-sectional schematic diagram illustrating the display device of FIG. 2A along a cutting line A-A. Referring to FIG. 2A and FIG. 2B, the display device 100 includes a display panel 110 and a light source module 200. The light source module 200 includes a light guide plate 210, a light source 220, and an adhesive material 230. The light guide plate 210 includes a light-coupling region CR and a light-emitting region ER. The display panel 110 is correspondingly disposed on the light-emitting region ER, wherein the display panel 110 is, for example, a transmissive display panel or a transflective display panel. However, the invention is not limited hereto. The light source 220 is, for example, a light-emitting diode (LED) chip. Moreover, in the embodiment, the number of the light source 220 is one, for example. In other unillustrated embodiments, the number of the light source 220 is more than one, for example, and the invention is not limited hereto. The adhesive material 230 is, for example, an optical adhesive material.

In the following paragraphs, the configuration relations among each of the elements in the light source module 200 will be detailed.

Referring to FIG. 2A and FIG. 2B, the light guide plate 210 of the light source module 200 includes the light-incident surface 212, the first surface 214, a second surface 216, a plurality of first microstructures 218, and a plurality of second microstructures 219. The light-coupling region CR is located between the light-incident surface 212 and the light-emitting region ER. The first surface 214 is, for example, connected to a top side of the light-incident surface 212 (parallel to the X-axis and perpendicular to the Y-axis and the Z-axis). The second surface 216 is, for example, connected to a bottom side of the light-incident surface 212 (parallel to the X-axis and perpendicular to the Y-axis and the Z-axis) and is disposed opposite to the first surface 214. In the embodiment, the first surface 214 and the second surface 216 are, for example, imaginary planes interior to the light guide plate 210, and the first surface 214 and the second surface 216 are parallel to each other. The first microstructures 218 are disposed in the light-emitting region ER and protrude from the first surface 214. The second microstructures 219 are disposed in the light-coup g region CR and protrude from at least one of the first surface 214 and the second surface 216. In the embodiment, the second microstructures 219 are disposed in the light-coupling region CR and protrude from the first surface 214. Moreover, surfaces of the first microstructures 218 and the second microstructures 219 facing outside of the light guide plate 210 are light-emitting surfaces of the light guide plate 210. In other unillustrated embodiments, the second microstructures 219 are disposed in the light-coupling region CR and protrude from the second surface 216, or the second microstructures 219 protrude from both the first surface 214 and the second surface 216. Where the second microstructures 219 protrude from the second surface 216, the surfaces of the second microstructures 219 facing outside of the light guide plate 210 are a bottom surface of the light guide plate 210, for example. In addition, a shape of the first microstructures 218 is different from a shape of the second microstructures 219. The light source 220 is disposed beside the light-incident surface 212. The adhesive material 230 is disposed between the light source 220 and the light-incident surface 212. In the embodiment, the light source 220 is, for example, adhered to the light guide plate 210 through the optical adhesive material.

Referring to FIG. 2B, the first microstructures 218 and the second microstructures 219 protrude from the first surface 214, and the first microstructures 218 and the second microstructures 219 are connected to each other. Specifically, in the embodiment, the light guide plate 210 further includes a gradation region GR. The light-coupling region CR includes a first light-coupling region CR1 and a second light-coupling region CR2. The light-emitting region ER includes a first light-emitting region ER1 and a second light-emitting region ER2. The second light-coupling region CR2 is adjacent to the second light-emitting region ER2. Specifically, the second light-coupling region CR2 is located between the second light-emitting region ER2 and the first light-coupling region CR1. The second light-emitting region ER2 is located between the first light-emitting region ER1 and the second light-coupling region CR2. The gradation region GR includes the second light-coupling region CR2 and the second light emitting region ER2. In the second light-coupling region CR2, a maximum height of the second microstructures 219 protruding from the first surface 214 gradually decreases in a direction extending from the first light-coupling region CR1 to a connection portion P between the second light-emitting region ER2 and the second light-coupling region CR2 (e.g., in the positive Y-axis direction). Moreover, the maximum height of the second microstructures 219 protruding from the first surface 214 gradually decreases to 0, for example (it should be noted that “height” refers to a relative height of the second microstructures 219 with respect to the first surface 214 or the second surface 216).

Next, in the second light-emitting region ER2, a maximum height of the first microstructures 218 protruding from the first surface 214 gradually increases in a direction extending from the connection portion P between the second light-emitting region ER2 and the second light-coupling region CR2 to the first light-emitting region ER1 (e.g., in the positive Y-axis direction). At the connection portion between the first microstructures 218 and the second microstructures 219 (i.e., the connection portion P between the second light-emitting region ER2 and the second light-coupling region CR2), the maximum height of the first microstructures 218 protruding from the first surface 214 is substantially equal to the maximum height of the second microstructures 219 protruding from the first surface 214 (e.g., both being 0). The configuration of the gradation region GR may prevent a phenomenon of light leakage of a light beam here. Moreover, in the first light-emitting region ER1, the maximum height of the first microstructures 218 protruding from the first surface 214 is substantially equal, and in the first light-coupling region CR1, the maximum height of the second microstructures 219 protruding from the first surface 214 is substantially equal.

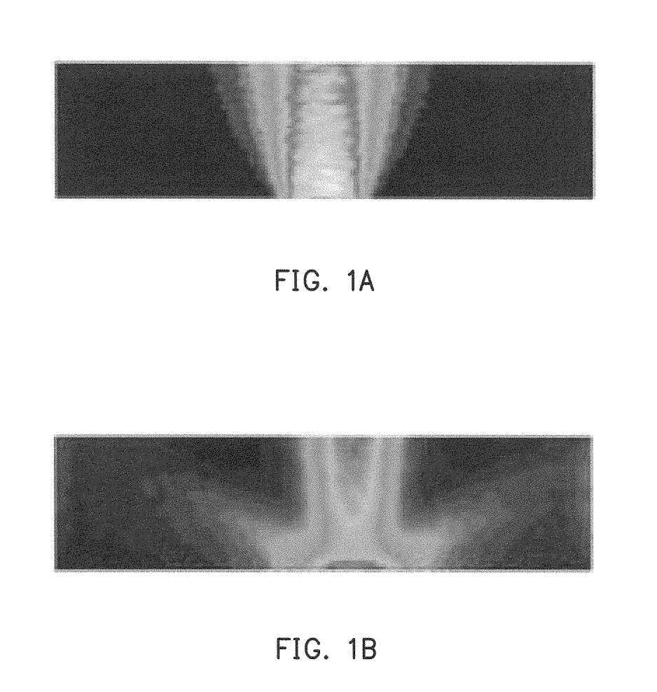

Referring to FIG. 2A and FIG. 2B, in the embodiment, the light source 220 is adapted to emit a light beam (not illustrated). The light beam is first transmitted in the adhesive material 230, directly exits from the adhesive material 230 via a contact portion between the adhesive material 230 and the light-incident surface 212, and is then incident to the light guide plate 210. Alternatively, the light beam is first reflected at an interface between the adhesive material 230 and an environmental medium (e.g., air), is transmitted to the contact portion between the adhesive material 230 and the light-incident surface 212, exits from the adhesive material 230, and then is incident to the light guide plate 210. Next, the light beam incident to the light guide plate 210 first enters the light-coupling region CR of the light guide plate 210. As the light beam is incident to the light-coupling region CR, due to the second microstructures 219 protruding from the first surface 214, an angle of total reflection of the light beam in the light-coupling region CR is changed, such that a proportion of total reflection of the light beam in the light guide plate 210 is effectively increased. Moreover, referring to FIG. 2C, FIG. 2C is a schematic diagram illustrating an optical simulation result of the light source module 200 of the embodiment. Compared with FIG. 1B, FIG. 2C shows that the light source module 200 of the embodiment may effectively mitigate phenomena of lateral stray light and light leakage. More specifically, part of the light beam that otherwise may not be transmitted toward the light-emitting region ER may now be transmitted toward the light-emitting region ER since an angle of progression is changed due to the second microstructures 219. Accordingly, the issue of light leakage of the light beam in the light-emitting region ER is avoided. In addition, the configuration of the second microstructures 219 also effectively mitigates the phenomenon of stray light as shown in FIG. 1B. Therefore, the light source module 200 of the embodiment may further enhance the effect of 1D local dimming.

Referring to FIG. 2D, FIG. 2D is a cross-sectional schematic diagram illustrating a display device 100′ along a cutting line A-A according to another embodiment of the invention. The display device 100′ is similar to the display device 100 of FIG. 2A and FIG. 2B, and the same elements are marked with the same numerals, which shall not be repeatedly described here. The main difference between the display device 100′ and the display device 100 lies in that a gap G exists between the first microstructures 218 and the second microstructures 219. Moreover, the gap G isolates the first microstructures 218 from the second microstructures 219.

Referring to FIG. 2E, FIG. 2E is a cross-sectional schematic diagram illustrating a display device 100″ along a cutting line A-A according to another embodiment of the invention. The display device 100″ is similar to the display device 100 of FIG. 2B, and the same elements are marked with the same numerals, which shall not be repeatedly described here. The main difference between the display device 100″ and the display device 100 lies in that in the light-emitting region ER, the maximum height of the first microstructures 218 protruding from the first surface 214 is substantially equal. In the light-coupling region CR, the maximum height of the second microstructures 219 protruding from the first surface 214 is substantially equal. In the connection portion between the first microstructures 218 and the second microstructures 219 (i.e., the connection portion P between the light-emitting region ER and the light-coupling region CR), the maximum height of the first microstructures 218 protruding from the first surface 214 is substantially equal to the maximum height of the second microstructures 219 protruding from the first surface 214.

In the following paragraphs, different embodiments of the first microstructures 218 and the second microstructures 219 will be detailed.

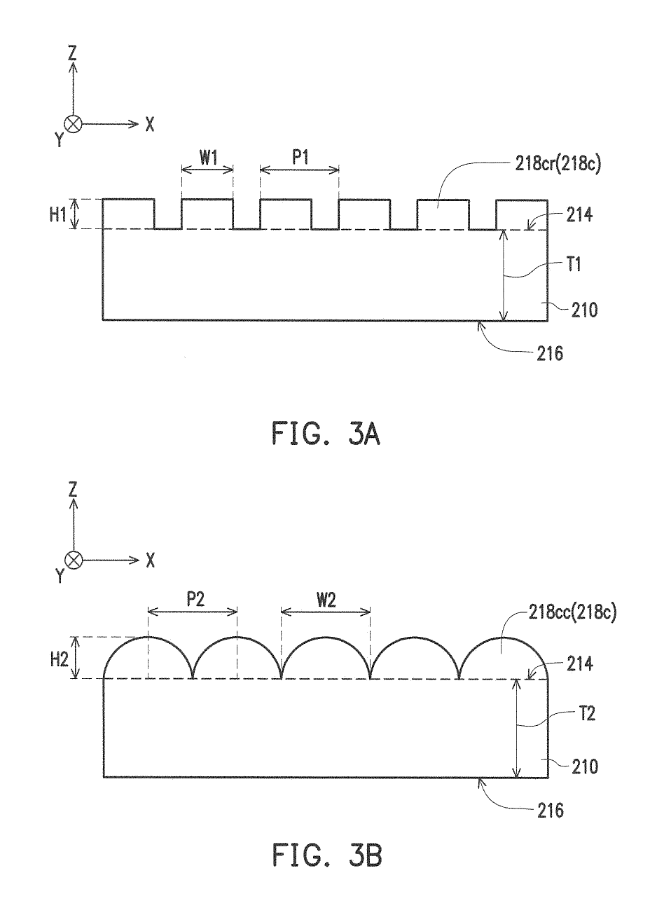

First, different embodiments of the first microstructures 218 are detailed. FIG. 3A and FIG. 3B are respectively cross-sectional schematic diagrams illustrating the display device of FIG. 2A along a cutting line B-B, wherein FIG. 3A and FIG. 3B are respectively possible embodiments of the first microstructures 218.

Referring to FIG. 2A and FIG. 3A, in the embodiment, each of the first microstructures is a first column structure 218c. An extension direction of the first column structure 218c is substantially perpendicular to the light-incident surface 212 (namely, extending along the positive Y-axis direction). Specifically, the first column structure 218c of FIG. 3A is a rectangular column structure 218cr, for example. The rectangular column structure 218cr satisfies the following relational expression:

0.4≦W1/P1≦0.8 and H1/(H1+T1)≦0.1,

wherein W1 is a projection width of the rectangular column structure 218cr, P1 is a pitch of two adjacent rectangular column structures 218cr, H1 is a height of the rectangular column structure 218cr protruding from the first surface 214, and T1 is a distance between the first surface 214 and the second surface 216. It should be mentioned that when the relational expression above is satisfied, the display device 100 has excellent optical quality.

Next, referring to FIG. 2A and FIG. 3B, the first column structure 218c of FIG. 3B is similar to the first column structure 218c illustrated in FIG. 3A. The main difference lies in that in FIG. 3B, the first column structure 218c is a cylindrical column structure 218cc, for example. The cylindrical column structure 218cc satisfies the following relational expression:

0.5≦W2/P2≦1,H2/(H2+T2)≦0.1, and 0.05≦P2/H2≦0.4,

wherein W2 is a projection width of the cylindrical column structure 218cc, P2 is a pitch of two adjacent cylindrical column structures 218cc, H2 is a maximum height of the cylindrical column structure 218cc protruding from the first surface 214, and T2 is a distance between the first surface 214 and the second surface 216. In one embodiment, W2 is 0.054 mm, P2 is 0.052 mm, H2 is 0.02 mm, and T2 is 0.53 mm. It should be mentioned that when the relational expression above is satisfied, the display device 100 has excellent optical quality.

Since the above-described first microstructures 218 of FIG. 3A or FIG. 3B are disposed in the light-emitting region ER, the effect of 1D local dimming of the light beam emitted by the light source 220 may be achieved in the light-emitting region ER.

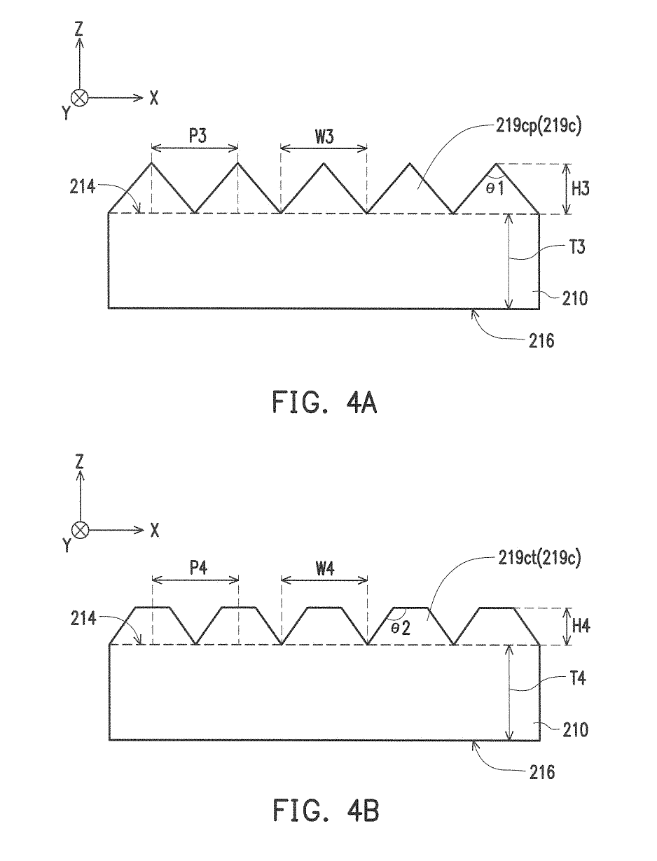

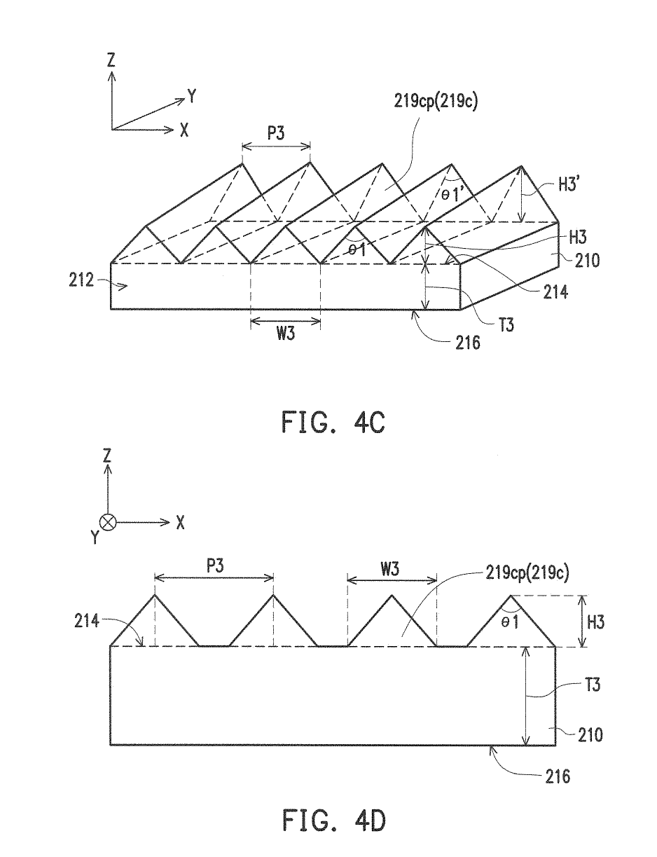

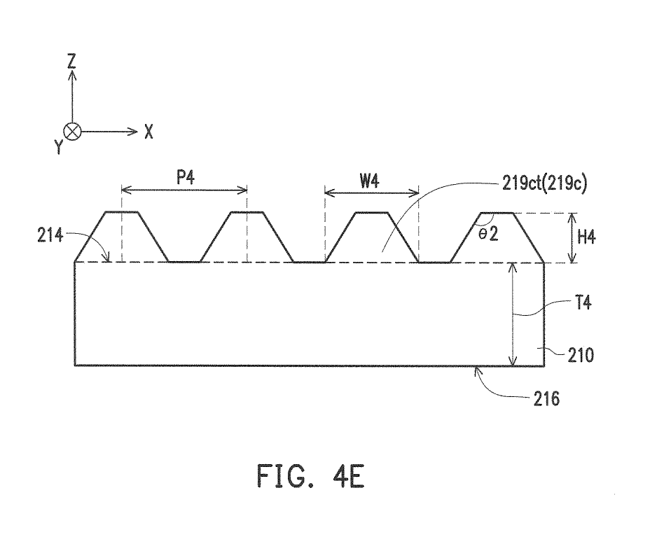

On the other hand, the different embodiments of the second microstructures 219 are detailed. FIG. 4A, FIG. 4B, FIG. 4D, and FIG. 4E are respectively cross-sectional schematic diagrams illustrating the display device of FIG. 2A along a cutting line C-C according to different embodiments. FIG. 4C is a perspective schematic diagram illustrating the second microstructures 219 in the display device of FIG. 2A. It should be noted that for clarity of description, FIG. 4C merely illustrates the second microstructures 219 in the display device of FIG. 2A, and the rest of the elements are omitted. FIG. 4A to FIG. 4E are respectively possible embodiments of the second microstructures 219.

First, referring to FIG. 2A and FIGS. 4A, 4D, in the embodiment, each of the second microstructures 219 is a second column structure 219c. An extension direction of the second column structure 219c is substantially perpendicular to the light-incident surface 212 (namely, extending toward the positive Y-axis direction). Specifically, the second column structure 219c is a prismatic column structure 219cp, for example. In the embodiment of FIG. 4A, the prismatic column structures 219cp are connected to each other. In the embodiment of FIG. 4D, the prismatic column structures 219cp are spaced apart at an interval. The above-described prismatic column structure 219cp satisfies the following relational expression:

0.1≦W3/P3≦1,H3/(H3+T3)≦0.1, and 90°≦θ1≦160°,

wherein W3 is a projection width of the prismatic column structure 219cp, P3 is a pitch of two adjacent prismatic column structures 219cp, H3 is a maximum height of the prismatic column structure 219cp protruding from the first surface 214, T3 is a distance between the first surface 214 and the second surface 216, and θ1 is an apex angle of the prismatic column structure. For example, in one embodiment, W3 is 0.052 mm, P3 is 0.052 mm, the apex angle θ1 is 130°, and T3 is 0.53 mm. It should be mentioned that when the relational expression above is satisfied, the display device 100 may effectively mitigate the phenomena of lateral stray light and light leakage, further enhance the effect of 1D local dimming, and have excellent optical quality. It should be noted that the embodiments in FIG. 4A and FIG. 4D merely illustrate the case where the prismatic column structure 219cp protrudes from the first surface 214. In other unillustrated embodiments, the prismatic column structure 219cp protrudes from the second surface 216, and in this case, H3 is a maximum height of the prismatic column structure 219cp protruding from the second surface 216.

Referring to FIG. 2A and FIGS. 4B, 4E, the second column structure 219c of FIGS. 4B, 4E is similar to the second column structure 219c illustrated in FIGS. 4A, 4D. The main difference lies in that in FIGS. 4B, 4E, the second column structure 219c is a trapezoidal column structure 219ct, for example. The trapezoidal column structure 219ct satisfies the following relational expression:

0.1≦W4/P4≦1,H4/(H4+T4)≦0.1, and 135°≦θ2≦170°,

wherein W4 is a projection width of the trapezoidal column structure 219ct, P4 is a pitch of two adjacent trapezoidal column structures 219ct, H4 is a maximum height of the trapezoidal column structure 219ct protruding from the first surface 214, T4 is a distance between the first surface 214 and the second surface 216; and θ2 is an apex angle θ2 of the trapezoidal column structure 219ct. It should be mentioned that when the relational expression above is satisfied, the display device 100 has excellent optical quality. It should be noted that the embodiments in FIG. 4B and FIG. 4E merely illustrate the case where the trapezoidal column structure 219ct protrudes from the first surface 214. In other unillustrated embodiments, the trapezoidal column structure 219ct protrudes from the second surface 216, and in this case, H4 is a maximum height of the trapezoidal column structure 219ct protruding from the second surface 216.

Referring to FIG. 2A and FIG. 4C, the second column structure 219c of FIG. 4C is similar to the second column structure 219c illustrated in FIG. 4A (i.e., both being the prismatic column structure 219cp). The main difference lies in that the maximum height H3 of the prismatic column structure 219cp protruding from the first surface 214 and the apex angle θ1 of the prismatic column structure 219cp are gradually variation along an extension direction (e.g., the positive Y-axis direction) of the prismatic column structure 219cp. For example, the maximum height protruding from the first surface 214 or the apex angle gradually increases (or gradually decreasing, for example, in other embodiments). Moreover, in other unillustrated embodiments, the prismatic column structure 219cp protrudes from the second surface 216, for example. In one embodiment, as the projection width W3 remains unchanged, the maximum height H3 of the prismatic column structure 219cp protruding from the first surface 214 at one end close to the light-incident surface 212 is smaller than the maximum height H3′ of the prismatic column structure 219cp protruding from the first surface 214 at the other end away from the light-incident surface 212. On the other hand, the apex angle θ1 of the prismatic column structure 219cp at one end close to the light-incident surface 212 is greater than the apex angle θ1′ of the prismatic column structure 219cp at the other end away from the light-incident surface 212. It should be mentioned that the prismatic column structure 219cp having angle variation and height variation along the extension direction as illustrated in FIG. 4C allows the light beam of total reflection at different angles to have different degrees of change in angles of total reflection so as to further mitigate light leakage.

In summary of the above, the embodiments of the invention may achieve at least one of the advantages or effects listed below. In the light source module of the embodiments of the invention, the adhesive material is disposed between the light source and the light guide plate. Moreover, the second microstructures protruding from at least one of the first surface and the second surface are disposed in the light-coupling region between the light-incident surface and the light-emitting region. Such configurations may effectively increase the proportion of total reflection of the light beam in the light guide plate, effectively mitigate the phenomena of lateral stray light and light leakage, and further enhance the effect of 1D local dimming. In addition, the second microstructures have different shapes, and when the shapes satisfy the relational expressions mentioned in the foregoing paragraphs, optical quality of the display device may be further enhanced. Since the display device of the embodiments of the invention includes the above-described light source module, the display device has excellent optical quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module comprising:
a light guide plate comprising a light-coupling region and a light-emitting region, the light guide plate comprising:
a light-incident surface, the light-coupling region being located between the light-incident surface and the light-emitting region;
a first surface connected to the light-incident surface;
a second surface connected to the light-incident surface and disposed opposite to the first surface;
a plurality of first microstructures disposed in the light-emitting region and protruding from the first surface; and
a plurality of second microstructures disposed in the light-coupling region and protruding from at least one of the first surface and the second surface, wherein a shape of the first microstructures is different from a shape of the second microstructures;
a light source disposed beside the light-incident surface; and
an adhesive material disposed between the light source and the light-incident surface.

2. The light source module according to claim 1, wherein the first microstructure is a first column structure, an extension direction of the first column structure being substantially perpendicular to the light-incident surface.

3. The light source module according to claim 2, wherein the first column structure is a rectangular column structure, the rectangular column structure satisfying the following relational expression:
0.4≦W1/P1≦0.8 and H1/(H1+T1)≦0.1,
wherein W1 is a projection width of the rectangular column structure, P1 is a pitch of two of the adjacent rectangular column structures, H1 is a height of the rectangular column structure protruding from the first surface, and T1 is a distance between the first surface and the second surface.

4. The light source module according to claim 2, wherein the first column structure is a cylindrical column structure, the cylindrical column structure satisfying the following relational expression:
0.5≦W2/P2≦1,H2/(H2+T2)≦0.1, and 0.05≦P2/H2≦0.4,
wherein W2 is a projection width of the cylindrical column structure, P2 is a pitch of two of the adjacent cylindrical column structures, H2 is a maximum height of the cylindrical column structure protruding from the first surface, and T2 is a distance between the first surface and the second surface.

5. The light source module according to claim 1, wherein the second microstructure is a second column structure, an extension direction of the second column structure being substantially perpendicular to the light-incident surface.

6. The light source module according to claim 5, wherein the second microstructures are spaced apart at an interval.

7. The light source module according to claim 5, wherein the second column structure is a prismatic column structure, the prismatic column structure satisfying the following relational expression:
0.1≦W3/P3≦1,H3/(H3+T3)≦0.1, and 90°≦θ1≦160°,
wherein W3 is a projection width of the prismatic column structure, P3 is a pitch of two of the adjacent prismatic column structures, H3 is a maximum height of the prismatic column structure protruding from the first surface or the second surface, T3 is a distance between the first surface and the second surface, and θ1 is an apex angle of the prismatic column structure.

8. The light source module according to claim 5, wherein the second column structure is a prismatic column structure, a maximum height of the prismatic column structure protruding from the first surface and an apex angle of the prismatic column structure are gradually variation from the light-incident surface along an extension direction of each of the prismatic column structures.

9. The light source module according to claim 5, wherein the second column structure is a trapezoidal column structure, the trapezoidal column structure satisfying the following relational expression:
0.1≦W4/P4≦1,H4/(H4+T4)≦0.1, and 135°≦θ2≦170°,
wherein W4 is a projection width of the trapezoidal column structure, P4 is a pitch of two of the adjacent trapezoidal column structures, H4 is a maximum height of the trapezoidal column structure protruding from the first surface or the second surface, T4 is a distance between the first surface and the second surface, and θ2 is an apex angle of the trapezoidal column structure.

10. The light source module according to claim 1, wherein the first microstructures and the second microstructures protrude from the first surface, a gap exists between the first microstructures and the second microstructures, and the gap isolates the first microstructures from the second microstructures.

11. The light source module according to claim 1, wherein the first microstructures and the second microstructures protrude from the first surface and the first microstructures are connected to the second microstructures.

12. The light source module according to claim 11, wherein the light guide plate further comprises a gradation region, the light-coupling region comprises a first light-coupling region and a second light-coupling region, the light-emitting region comprises a first light-emitting region and a second light-emitting region, the second light-coupling region is adjacent to the second light-emitting region, wherein the gradation region comprises the second light-coupling region and the second light-emitting region, wherein in the second light-coupling region, a maximum height of the second microstructures protruding from the first surface gradually decreases in a direction extending from the first light-coupling region to a connection portion between the second light-emitting region and the second light-coupling region, wherein in the second light-emitting region, a maximum height of the first microstructures protruding from the first surface gradually increases in a direction extending from the connection portion between the second light-emitting region and the second light-coupling region to the first light-emitting region, wherein in a connection portion between the first microstructures and the second microstructures, a maximum height of the first microstructures protruding from the first surface is substantially equal to a maximum height of the second microstructures protruding from the first surface.

13. The light source module according to claim 11, wherein in the light-emitting region, a maximum height of the first microstructures protruding from the first surface is substantially equal, wherein in the light-coupling region, a maximum height of the second microstructures protruding from the first surface is substantially equal, wherein in a connection portion between the first microstructures and the second microstructures, a maximum height of the first microstructures protruding from the first surface is substantially equal to a maximum height of the second microstructures protruding from the first surface.

14. A display device comprising:
a display panel; and
a light source module comprising:
a light guide plate comprising a light-coupling region and a light-emitting region, the display panel being correspondingly disposed on the light-emitting region, the light guide plate comprising:
a light-incident surface, the light-coupling region being between the light-incident surface and the light-emitting region;
a first surface connected to the light-incident surface;
a second surface connected to the light-incident surface and disposed opposite to the first surface;
a plurality of first microstructures disposed in the light-emitting region and protruding from the first surface; and
a plurality of second microstructures disposed in the light-coupling region and protruding from at least one of the first surface and the second surface, wherein a shape of the first microstructures is different from a shape of the second microstructures;
a light source disposed beside the light-incident surface; and
an adhesive material disposed between the light source and the light-incident surface.
